(19) United States
(12) Patent Application Publication
(10) Pub. No.: US 2011/0047623 A1
(43) Pub. Date: Feb. 24, 2011

(54) APPARATUS AND METHOD FOR TRACING WEB USER USING SIGNED CODE

(76) Inventors: Beom Hwan Chang, Daejeon (KR); Chi Yoon Jeong, Daejeon (KR); A Ra Jo, Seoul (KR); Jung Chan Na, Daejeon (KR); Hyun Sook Cho, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/691,654

(22) Filed: Jan. 21, 2010

(30) Foreign Application Priority Data
Aug. 19, 2009 (KR) 10-2009-0076832

(51) Int. Cl. G06F 15/173; G06F 21/00

(52) U.S. Cl. 726/26; 709/224

(57) ABSTRACT

Provided are an apparatus and method for tracing web user using signed code. The apparatus for tracing web user includes at least one access terminal, a web server, and a monitoring server. The at least one access terminal requests a web page. The web server provides the web page including a signed code to the each access terminal according to the request. The monitoring server receives and analyzes access information which is extracted from the each access terminal according to execution of the signed code.

### CROSS-REFERENCE TO RELATED APPLICATIONS

This application claims priority under 35 U.S.C. §119 to Korean Patent Application No. 10-2009-0076832, filed on Aug. 19, 2009, in the Korean Intellectual Property Office, the disclosure of which is incorporated herein by reference in its entirety.

### TECHNICAL FIELD

The following disclosure relates to a method for tracing web user, and in particular, to an apparatus and method for tracing web user using signed code, which traces a web user with a signed code.

### BACKGROUND

As Internet users rapidly increases, all sorts of criminal acts are increasing over the Internet. However, because most Internet traffics are concentrated on Hyper Text Transmission Protocol (HTTP(s))-based web service having an open structure, Internet infringers easily access a web server to perform unlawful acts and hide the unlawful acts. Therefore, a web service provider applies a web trace scheme for coping with the unlawful act, thereby strengthening the security of web service.

A related art web tracing scheme analyzes the header or access information of a network packet that accesses a web server to obtain a sending address and a destination address, and estimates the access path of an access user on the basis of the obtained addresses. However, when the access user passes through an anonymous proxy server, the related art web tracing scheme cannot find the information of an actual access user.

For solving these limitations, a reverse tracing scheme based on java script, java applet and Active-X was considered, but it cannot perform reverse tracing when strengthening the security of a web browser, blocking popup and executing a separate security program.

Another related art web tracing scheme obtains the information of the access user using an Internet connection program being executed by the web browser of an access user. However, the other related art web tracing scheme additionally should analyze a communication system that goes round a proxy, and moreover, it has limitations in obtainable information.

A related art web tracing scheme using plug-in should control plug-in through a bi-directional communication, and has limitations in extractable information.

### SUMMARY

In one general aspect, an apparatus for tracing web user using signed code includes: at least one access terminal requesting a web page; a web server providing the web page including a signed code to the each access terminal according to the request; and a monitoring server receiving and analyzing access information which is extracted from the each access terminal according to execution of the signed code.

In another general aspect, an apparatus for tracing web user using signed code includes: a signed code generation unit sending a web page, into which a signed code is inserted, to at least one access user which requests the web page; an information collection unit collecting access information of each access user which is extracted according to execution of the signed code; and an information display unit displaying the collected access information.

In another general aspect, a method for tracing web user using signed code includes: generating a signed code which extracts access information of each access user; inserting the generated signed code into a web page which is requested by the each access user; and sending the web page, into which the signed code is inserted, to the each access user.

In another general aspect, a method for tracing web user using signed code includes: collecting access information of each access user as a signed code is executed by sending a web page, into which a signed code is inserted, to each access user which requests a web page; and displaying the collected access information.

Other features and aspects will be apparent from the following detailed description, the drawings, and the claims.

### BRIEF DESCRIPTION OF THE DRAWINGS

FIG. 1 is a block diagram illustrating an apparatus for tracing web user using signed code according to an exemplary embodiment.

FIG. 2 is a block diagram illustrating an apparatus for tracing web user using signed code according to another exemplary embodiment.

FIG. 3 is a flow chart illustrating a method for tracing web user using signed code according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

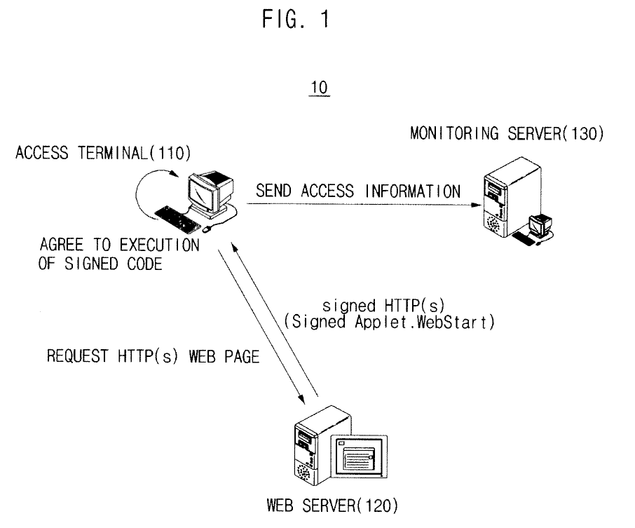

Hereinafter, an apparatus for tracing web user using signed code according to an exemplary embodiment will be described with reference to FIG. 1.

FIG. 1 is a block diagram illustrating an apparatus for tracing web user using signed code according to an exemplary embodiment.

Referring to FIG. 1, an apparatus 10 for tracing web user using signed code according to an exemplary embodiment includes at least one access terminal 110, a web server 120, and a monitoring server 130.

The each access terminal 110 accesses the web server 120 to request an HTTP(s) web page. The each access terminal 110 receives a web page (for example, signed HTTP(s)) including a signed code (for example, signed applet, Webstart) and agrees to the executing of the signed code, thereby viewing a web page. At this point, when the each access terminal 100 agrees to the executing of the signed code, the web server 120 allows viewing of the web page. When the each access terminal 100 disagrees executing of the signed code, the web server 120 disallows further viewing of the web page.

The signed code internally includes proxy information, and in execution, it extracts the access information of the each access terminal 110 to provide the extracted access information to the monitoring server 130.

The web server 120 obtains the agreement of an access user for execution before executing the signed code and lawfully collects the access information of the access user, thereby preventing a legal dispute.

The web server 120 inserts a signed code, from which the access information of the each access terminal 110 may be extracted, into the web page, and provides a web page including the signed code according to the web page request of the each access terminal 110. Herein, the access information includes at least one of the Internet Protocol (IP) address, network information, manager information, system information, proxy information, access path information and geographic information for the position of the each access terminal 110. Moreover, the signed code may be one that has been pre-signed by a reliable organization such as recognized organizations, and can improve reliability for the web page.

The monitoring server 130 receives and analyzes access information that is extracted from the each access terminal 110 according to the execution of the signed code in the each access terminal 110. At this point, the monitoring server 130 always waits for receiving access information that is sent from the signed code.

In detail, the monitoring server 130 determines whether to use a proxy server on the basis of the extracted access information, and may check the actual IP address of the access terminal 110 instead of the proxy server to map access information and access path into a physical position, a country and an organization on a digital map, thereby displaying a result of the mapping.

To provide a brief description, the user of the access terminal 110 requests a web page associated with information necessary for the web server 120, and the web server 120 sends a web page including the signed code in response to the request. Accordingly, when the user intends to view the web page through a web browser, a popup window for querying whether to agree to the execution of the signed code is opened. When the user agrees to the execution of the signed code, the web server 120 gives authorization for continuously viewing the web page, and the signed code extracts the access information of the access terminal 110 to send the extracted access information to the monitoring server 130. The monitoring server 130 receives, analyzes and stores the sent access information, and the stored information may be used for service that provides the access information of the user and the access terminal 110 together with geographic information to another user.

The web server 120 or the monitoring server 130 may limit the providing of service for a proxy server or a user that does not agree to the execution of the signed code, and it may add the user or the proxy server to a risk list and manage the potential risk list.

According to an exemplary embodiment, by adding a signed code that has been pre-signed by a reliable organization such as recognized organizations to a web page, the apparatus 10 can improve reliability for materials, documents and programs that may be sent through a web page and the Web. Even when an access user directly accesses a web server or accesses the web server by passing through the proxy server, the apparatus 10 can check the network information and position of the access user.

According to an exemplary embodiment, furthermore, although the apparatus 10 does not capture a packet that is sent, install a separate agent program, or use the plug-in of a web browser, additional plug-in and a separate communication protocol, the apparatus 10 may check the network information and position of the access user. Thereby the apparatus 10 can quickly and easily trace the IP address and system information of the access user.

In addition, because the apparatus 10 may apply the same algorithm irrespective of the kind of the proxy server that is passed thmugh, it need not determine the kind of the proxy server or separately configure an algorithm based on the kind of the proxy server.

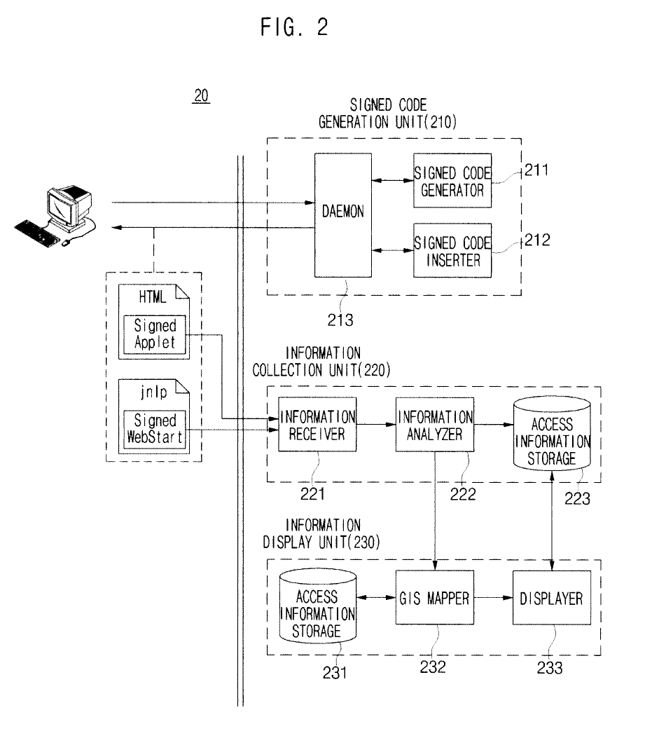

Hereinafter, an apparatus for tracing web user using signed code according to another exemplary embodiment will be described with reference to FIG. 2. FIG. 2 is a block diagram illustrating an apparatus for tracing web user using signed code according to another exemplary embodiment.

Referring to FIG. 2, an apparatus for tracing web user using signed code 20 according to another exemplary embodiment includes a signed code generation unit 210, an information collection unit 220, and an information display unit 230.

The signed code generation unit 210 sends a web page, into which a signed code is inserted, to at least one access user that requests a web page.

The signed code generation unit 210 includes a daemon 213, a signed code generator 211, and a signed code inserter 212.

The signed code generator 211 generates a signed code that extracts access information related to the execution of a computer and the access through a network, from the computer of each access user. At this point, the signed code generator 211 updates the signed code, and manages a history that is generated, updated and sent.

The signed code inserter 212 inserts the generated signed code into a web page. At this point, he web page may be one that is included in the Hyper Text Markup Language (HTML) document and the jnlp (Java Web Start) document.

The daemon 213 sends a web page, into which the signed code is inserted, to each access user that is outputted from the signed code inserter 212 according to the web page request of the each access user.

The information collection unit 220 collects the access information of the each access user that is extracted according to the execution of the signed code. The information collector 220 includes an information receiver 221, an information analyzer 222, and an access information storage 223.

As the signed code is executed in the computer of the access user, the information receiver 221 receives access information that is extracted by the signed code. The information analyzer 222 analyzes the received access information to check the information of the access user. The access information storage 223 stores access information, which is received and analyzed for providing subsequent service, in an information database. Herein, the access information includes at least one of the IP address, network information (for example, an access network and a network operator), manager information (for example, a user identification (ID)), system information (for example, an operating system (OS)), proxy information and access path information of an access user computer.

The information display unit 230 maps each collected access information on Geographic Information System (GIS) to displays it.

The information display unit 230 includes a geographic information storage 231, a GIS mapper 232, and a displayer 233.

The geographic information storage 231 includes at least one GIS information of traffic information, digital topographical map, satellite photograph and aerial photograph.

The GIS mapper 232 maps collected access information on the GIS information. That is, the GIS mapper 232 maps access information on a digital map on the basis of the access information and the GIS information, and provides mapped data to the displayer 233.

As a display means such as Liquid Crystal Displays (LCD), the displayer 233 displays the mapped data.

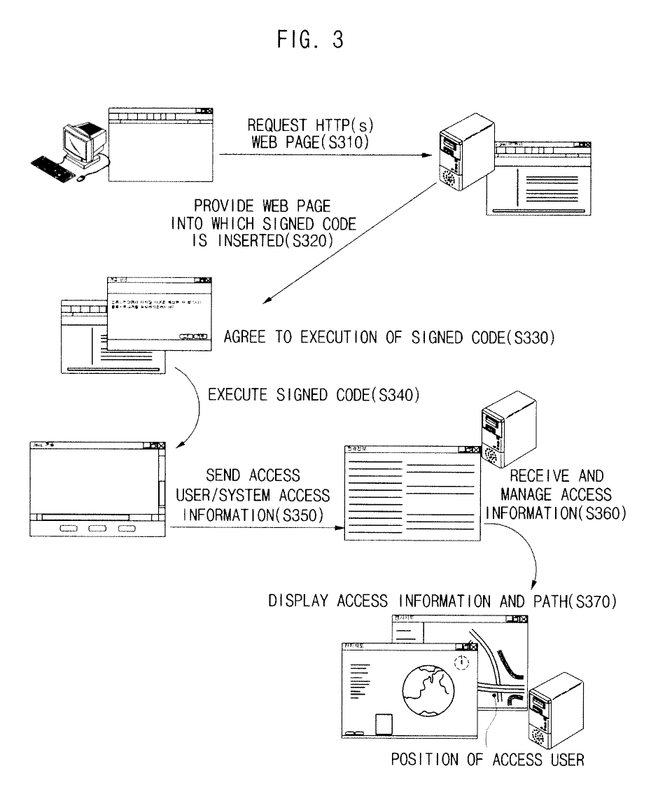

Hereinafter, a method for tracing web user using signed code according to an exemplary embodiment will be described with reference to FIG. 3. FIG. 3 is a flow chart illustrating a method for tracing web user using signed code according to an exemplary embodiment.

Referring to FIG. 3, the apparatuses 10 and 20 for tracing web user using signed code checks whether a web page request is received from each access user in S310.

Subsequently, the apparatuses 10 and 20 send a web page, into which a signed code for a corresponding Uniform Resource Locator (URL) is inserted, to the each access user that sends the web page request in S320.

The apparatuses 10 and 20 query whether to agree to the execution of the signed code over the web browser of the access user in S330.

When the access user agrees to the execution of the signed code, the apparatuses 10 and 20 execute the signed code and allow viewing of the web page, which is performed over the web browser, to the access user in S340.

The signed code is executed in the computer of the access user, whereupon access user information, system information and proxy information are collected. The collected information is sent to the web server 120 or the monitoring server 130 in S350.

The web server 120 or the monitoring server 130 receives the access user information, the system information and the proxy information, and stores and manages all the received information in S360.

The apparatuses 10 and 20 map access information on GIS information to display mapped data in S370. Herein, the GIS information includes at least one of traffic information, digital topographical map, satellite photograph and aerial photograph.

In this way, the apparatuses 10 and 20 display an access user, a system and a proxy on an accurate and vivid digital map, and thus support that each user can instinctively perceive information associated with access paths and each access user.

In other words, the apparatuses 10 and 20 three-dimensionally display the access path of each access user through satellite photographs, and moreover, provide the accurate position information of a building in which the each access user is disposed through high-accurate geographic information and each IP address.

Moreover, the apparatuses 10 and 20 provide high-resolution digital maps and access information, including access user information and access path information through vector-based digital topographical maps, irrespective of the zooming in and out of maps.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for tracing web user using signed code, the apparatus comprising:
at least one access terminal requesting a web page;
a web server providing the web page comprising a signed code to the each access terminal according to the request; and
a monitoring server receiving and analyzing access information which is extracted from the each access terminal according to execution of the signed code.

2. The apparatus of claim 1, wherein the each access terminal agrees or disagrees to the execution of the signed code when receive the web page comprising the signed code.

3. The apparatus of claim 2, wherein:
the web server allows viewing of the web page when the each access terminal agrees to the execution of the signed code, and
the web server disallows viewing of the web page when the each access terminal disagrees to the execution of the signed code.

4. The apparatus of claim 1, wherein the signed code collects access information of the each access terminal to send the collected information to the monitoring server, in execution of the signed code.

5. The apparatus of claim 1, wherein the access information comprises at least one of an Internet Protocol (IP) address, network information, manager information, system information, proxy information, access path information and geographic information.

6. The apparatus of claim 5, wherein the monitoring server traces a position of the each access terminal on the basis of the access information, and maps and displays the traced position on a digital map.

7. An apparatus for tracing web user using signed code, the apparatus comprising:
a signed code generation unit sending a web page, into which a signed code is inserted, to at least one access user which requests the web page;
an information collection unit collecting access information of each access user which is extracted according to execution of the signed code; and
an information display unit displaying the collected access information.

8. The apparatus of claim 7, wherein the signed code generation unit comprises:
a signed code generator generating the signed code which extracts the access information from a computer of the each access user;
a signed code inserter inserting the generated signed code into the web page; and
a daemon sending the web page, into which the signed code is inserted, to the each access user.

9. The apparatus of claim 7, wherein the information collection unit comprises:
an information receiver receiving the each access information;
an information analyzer analyzing the received access information; and
an access information storage storing the received and analyzed access information.

10. The apparatus of claim 7, wherein the information display unit comprises:
a geographic information storage storing Geographic Information System (GIS) information;
a GIS mapper mapping the collected access information on the GIS information; and
a displayer displaying the mapped access information.

11. The apparatus of claim 7, wherein the information display unit changes the each access information into a physical position, a country and an organization to display the changed information on a digital map.

12. The apparatus of claim 7, wherein the access information comprises at least one of an Internet Protocol (IP) address, network information, manager information, system information, proxy information and access path information.

13. A method for tracing web user using signed code, the method comprising:
generating a signed code which extracts access information of each access user;
inserting the generated signed code into a web page which is requested by the each access user; and
sending the web page, into which the signed code is inserted, to the each access user.

14. The apparatus of claim 13, wherein execution of the signed code is determined on a computer of the each access user according to agreement or disagreement of the each access user.

15. The apparatus of claim 14, wherein:
a web browser and the signed code are executed according to the agreement of the each access user, and
the access information is extracted when the signed code is executed.

16. The apparatus of claim 14, wherein a web browser is blocked according to the disagreement of the each access user.

17. A method for tracing web user using signed code, the method comprising:
collecting access information of each access user as a signed code is executed by sending a web page, into which a signed code is inserted, to each access user which requests a web page; and
displaying the collected access information.

18. The method of claim 17, wherein the collecting of access information comprises:
receiving an extracted access information by executing the signed code; and
analyzing and storing the received access information.

19. The method of claim 17, wherein the displaying of the collected access information comprises:
storing Geographic Information System (GIS) information; and
mapping the collected access information on the stored GIS information; and
displaying the mapped information.

20. The method of claim 19, wherein the GIS information comprises at least one of traffic information, a digital topographical map, satellite photograph and aerial photograph.
